(19) United States
(12) Patent Application Publication
(10) Pub. No.: US 2009/0274880 A1
(43) Pub. Date: Nov. 5, 2009

(54) Synthetic Resin Air Bubble Sheet

(75) Inventors: Masamoto Iwasaka, Nagoya-city (JP); Tatsuo Ichikawa, Nagoya-city (JP)

Correspondence Address: POSZ LAW GROUP, PLC, 12040 SOUTH LAKES DRIVE, SUITE 101, RESTON, VA, 20191, US

(73) Assignee: Kawakami Sangyo Co., Ltd., Nagoya-shi, Aich (JP)

(21) Appl. No.: 12/085,227

(22) PCT Filed: Nov. 9, 2006
(86) PCT No.: PCT/JP2006/322331

§ 371 Date: May 20, 2008

(30) Foreign Application Priority Data
Nov. 21, 2005 (JP) 2005-335865

(51) Int. Cl. B32B 3/12

(52) U.S. Cl. 428/178

(57) ABSTRACT

To make a thickness of a concavo-convex sheet as uniform as possible while ensuring the function of an air bubble sheet as a cushioning material. A synthetic resin air bubble sheet is provided in which a concavo-convex sheet (11) and a flat sheet (12) are joined and a plurality of air bubble portions (13) are formed that form sealed spaces between the concavo-convex sheet (11) and the flat sheet (12). Each of the air bubble portions (13) has a circular truncated cone shape whose diameter becomes smaller toward the top. Where A is the diameter of the part with the largest diameter, a height B from the flat sheet (12) is in the range of 35% to 40% of A, a diameter C of a flat top portion (11d), which is the part with the smallest diameter, is in the range of 50% to 80% of A, and a radius of curvature R of a top corner portion (11c) that is formed between the flat top portion (11d) and a side wall portion (11b) is in the range of 10% to 20% of A.

### FIELD OF THE INVENTION

The present invention relates to a synthetic resin air bubble sheet in which a flat sheet is joined to a concavo-convex sheet formed with a plurality of concavo-convex portions to form a plurality of air bubble portions in which a gas is sealed.

### BACKGROUND OF THE INVENTION

A synthetic resin air bubble sheet in which a flat sheet is joined to a concavo-convex sheet in which a plurality of concavo-convex protruding portions are formed is known to be widely used for packaging material and the like. A cross section structure of a known air bubble sheet J10 is shown in FIG. 5. As shown in FIG. 5, a flat sheet J12 is joined to a concavo-convex sheet J11, and a gas is sealed in a cylindrical air bubble portion J13. In a case where a load bears on the air bubble portion J13, the presence of the gas inside the air bubble portion J13 allows the tensile strength of the thin concavo-convex sheet J11 to withstand the load. In other words, the air bubble sheet is structured as a cushioning material that maximizes the strength of the thin sheet by converting compression of the air bubble portion J13 into tension.

In order to maximize the tensile strength of the concavo-convex sheet J11 that is structured in this manner, it is ideal for the thickness of the concavo-convex sheet J11 to be uniform in all locations. More specifically, it is desirable for a thickness t1 of a joined portion J11a that is joined to the flat sheet J12, a thickness t2 of a side wall portion J11b, a thickness t3 of a top corner portion J11c, and a thickness t4 of a flat top portion J11d to be nearly equal.

In the known air bubble sheet, dimension ratios for the concavo-convex sheet J11 that forms the air bubble portion J13 are generally set in the following manner. Where A is a diameter of a portion of the concavo-convex sheet J11 that is joined to the flat sheet J12, a height B of the side wall portion J11b is set to 40% of A, a radius of curvature R of the top corner portion J11c is set to 10% of A, and a diameter C of the flat top portion J11d is set equal to A.

However, according to studies by the inventor, in a case where the air bubble sheet is manufactured using the dimension ratios described above, the distribution of the thicknesses in the concavo-convex sheet J11 is such that t1 is the thickest, t2 is three-fourths of t1, t3 is one-fourth of t1, and t4 is one-half of t1. Therefore, in the concavo-convex sheet J11, the thickness t3 of the thinnest portion, where the sheet is the thinnest, is one-fourth of the thickness t1 of the thickest portion, where the sheet is the thickest. The strength of the concavo-convex sheet J11 is determined by the thickness of the thinnest portion, where the sheet is the thinnest, so the portions where the thickness is greater than that of the thinnest portion do not contribute to strength, but merely waste material and become dead weight. This creates a problem in that the air bubble sheet becomes disproportionately heavy for its strength.

Furthermore, it is conceivable that the variation in the thickness distribution of the concavo-convex sheet J11 could be reduced by lowering the height B of the side wall portion J11b, such that the amount of elongation of the sheet during the manufacture of the concavo-convex portions is reduced. However, if the height B of the side wall portion J11b is lowered, the possibility arises that when the load bears on the air bubble portion J13, the flat top portion J11d will touch the bottom of the air bubble portion J13. This creates a problem in that it impairs the functioning of the air bubble sheet as a cushioning material.

### SUMMARY OF THE INVENTION

The present invention addresses these points, and it is an object thereof to make the thickness of the concavo-convex sheet as uniform as possible, while ensuring the functioning of the air bubble sheet as a cushioning material.

In order to achieve the above object, a synthetic resin air bubble sheet is provided in which a concavo-convex sheet (11) and a flat sheet (12) are joined and a plurality of air bubble portions (13) are formed that form sealed spaces between the concavo-convex sheet (11) and the flat sheet (12). Each of the air bubble portions (13) has a circular truncated cone shape whose diameter becomes smaller toward the top. Where A is the diameter of the part with the largest diameter, a height B from the flat sheet (12) is in the range of 35% to 40% of A, a diameter C of a flat top portion (11d), the part with the smallest diameter, is in the range of 50% to 80% of A, and a radius of curvature R of a top corner portion (11c) that is formed between the flat top portion (11d) and a side wall portion (11b) is in the range of 10% to 20% of A.

This makes it possible to limit unevenness in the thickness of the concavo-convex sheet that forms the sealed air bubble portions, while ensuring the function of the air bubble sheet as a cushioning material by inhibiting the flat top portions from touching the bottoms of the air bubble portions when a load bears on the air bubble portions.

Furthermore, even if the thickness of the concavo-convex sheet that forms the air bubble portions is made thin, a strength that is equivalent to that of the known synthetic resin air bubble sheet can be ensured, so the synthetic resin air bubble sheet according to the present invention can promote weight reduction. The volume of the synthetic resin air bubble sheet according to the present invention can also be made significantly smaller than that of the known synthetic resin air bubble sheet, so storage efficiency during storage and loading efficiency during transport can be greatly improved.

The synthetic resin air bubble sheet according to the present invention can also reduce the amount of raw material that is used, so it contributes to conservation of petroleum resources. Moreover, when the synthetic resin air bubble sheet according to the present invention is discarded and burned, it can reduce fuel calorie consumption and reduce the amount of carbon dioxide emissions.

Note that the reference numerals in parentheses for the various portions described above are used to indicate correspondences to specific portions that are described later in an embodiment.

### BRIEF DESCRIPTION OF THE DRAWINGS

FIG. 1 is an oblique view of a synthetic resin air bubble sheet according to an embodiment.

FIG. 2 is a sectional view of the synthetic resin air bubble sheet according to the embodiment.

FIG. 3 is an enlarged sectional view that shows an air bubble portion of the synthetic resin air bubble sheet according to the embodiment.

FIG. 4 is a schematic diagram that shows main structural portions of an apparatus that manufactures the synthetic resin air bubble sheet according to the embodiment.

FIG. 5 is an enlarged sectional view that shows an air bubble portion of a known air bubble sheet.

### DETAILED DESCRIPTION OF THE EMBODIMENTS

### First Embodiment

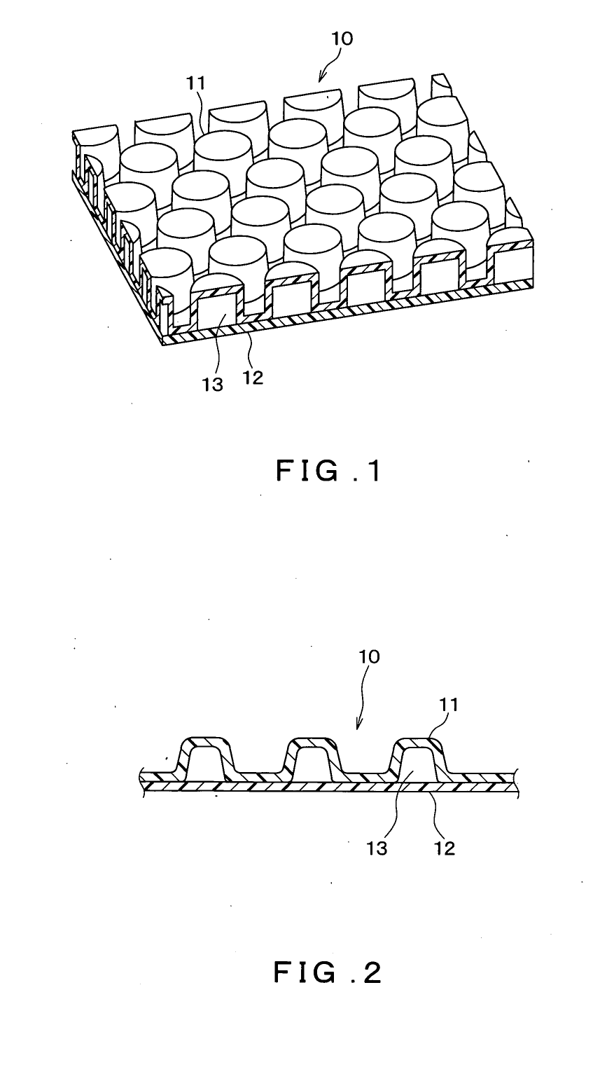

Embodiments of the present invention will be explained below based on FIGS. 1 to 5. FIG. 1 is an oblique view of a synthetic resin air bubble sheet according to an embodiment of the present invention, and FIG. 2 is a sectional view.

As shown in FIGS. 1 and 2, an air bubble sheet 10 according to the present embodiment has a two-layer structure that is formed from a flat sheet 12 (a back film) that is flat and a concavo-convex sheet (a cap film) 11 that is formed from a plurality of concavo-convex protruding portions. A plurality of cylindrical protruding portions are embossed on the concavo-convex sheet 11, and a side of the concavo-convex sheet 11 where openings of the protruding portions are located is joined to the flat sheet 12. This causes an air bubble portion 13 in which air is sealed to be formed between the concavo-convex sheet 11 and the flat sheet 12.

In the present embodiment, it is desirable for a polyolefin type of resin such as polyethylene or polypropylene to be used as the synthetic resin that forms the air bubble sheet 10, and for uses where flexibility is required, it is desirable to use polyethylene. Moreover, for a use like packing material, where flexibility is required, it is desirable for the synthetic resin air bubble sheet 10 to have a weight per unit area of 35 to 200 grams per square meter.

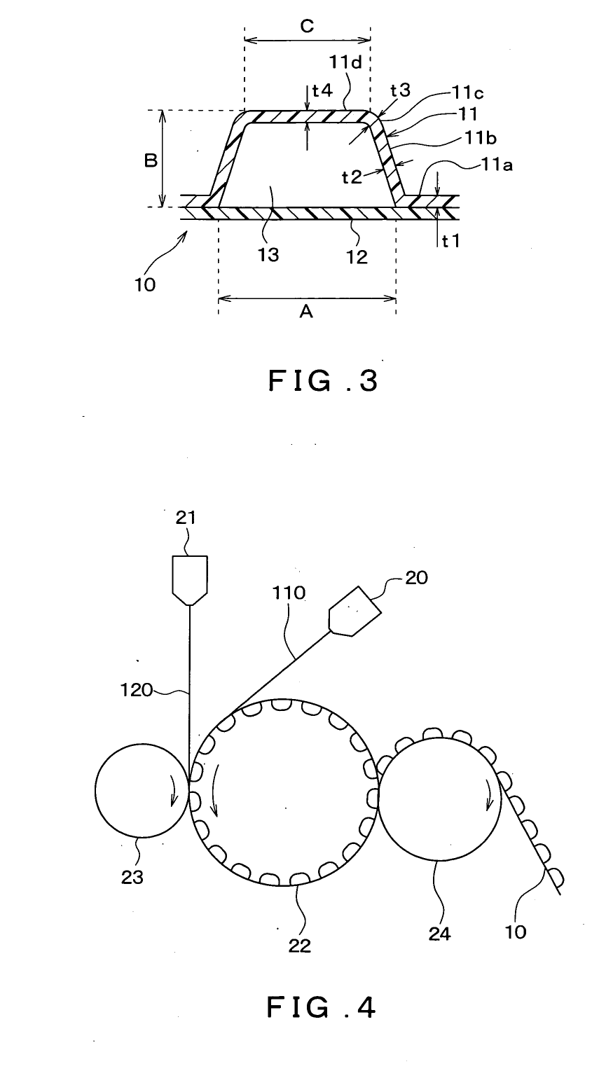

Next, dimension ratios for the concavo-convex sheet 11 that forms the air bubble portion 13 of the air bubble sheet 10 according to the present embodiment will be explained based on FIG. 3. FIG. 3 is an enlarged sectional view that shows the air bubble portion 13 of the air bubble sheet 10 according to the present embodiment. As shown in FIG. 3, the air bubble portion 13 according to the present embodiment has a trapezoidal cross section shape, forming a circular truncated cone whose diameter diminishes gradually-toward the top.

In the present embodiment, the dimension ratios for the concavo-convex sheet 11 are set as described below in order to make a thickness t1 of a joined portion 11a that is joined to the flat sheet 12, a thickness t2 of a side wall portion 11b, a thickness t3 of a top corner portion 11c that is formed at a boundary of the sidewall portion 11b and a flat top portion 11d, and a thickness t4 of the flat top portion 11d as uniform as possible.

Specifically, where A is the diameter of the part of the air bubble portion 13 with the largest diameter, that is, the part where the concavo-convex sheet 11 is joined to the flat sheet 12, a height B of the side wall portion 11b is set in the range of 35% to 40% of A, and a radius of curvature R of the top corner portion 11c is set in the range of 10% to 20% of A. A diameter C of the part of the air bubble portion 13 with the smallest diameter, that is, the flat top portion 11d, is set in the range of 50% to 80% of A. The height B of the side wall portion 11b is the shortest distance from the flat sheet 12 to the flat top portion 11d of the concavo-convex sheet 11. In the present embodiment, A is set to 10 mm, and in the concavo-convex sheet 11, the height B of the side wall portion 11b is set to 3.5 mm (35% of A), the radius of curvature R of the top corner portion 11c is set to 1 mm (10% of A), and the diameter of the flat top portion 11d is set to 8 mm (80% of A).

FIG. 4 shows an example of main structural portions of an air bubble sheet manufacturing apparatus that manufactures the air bubble sheet 10 according to the present embodiment. As shown in FIG. 4, two synthetic resin sheet supply portions 20, 21 are provided. A synthetic resin sheet 110 that will become the concavo-convex sheet 11 is supplied from a first synthetic resin sheet supply portion 20, and a synthetic resin sheet 120 that will become the flat sheet 12 is supplied from a second synthetic resin sheet supply portion 21. Each of the sheet supply portions 20, 21 is configured from a flat die that is connected to an extrusion machine (not shown in the drawing). The air bubble sheet manufacturing apparatus is also provided with a pressure roller 23 and a forming roller 22, on the circumference of which a plurality of concave portions is formed.

Each of the plurality of concave portions that is formed on the surface of the forming roller 22 corresponds to the air bubble portion 13 in the air bubble sheet 10. The pattern of the concave portions on the forming roller 22 is formed with the dimension ratios of the concavo-convex sheet 11 shown in FIG. 3 and described above. The bottoms of the concave portions on the forming roller 22 are connected to a vacuum pump that is not shown in the drawing, such that vacuum suction can be applied in the concave portions.

Next, an example of a manufacturing method for the air bubble sheet 10 according to the present embodiment will be explained. The synthetic resin sheet 110 is supplied from the first synthetic resin sheet supply portion 20 at a high temperature, then is sucked by the vacuum on the forming roller 22 such that a concavo-convex pattern that forms the air bubble portion 13 is formed, creating the concavo-convex sheet 11. The synthetic resin sheet 120 is supplied from a second synthetic resin sheet supply portion 21 at a high temperature, then is pressed against the concavo-convex sheet 11 by the pressure roller 23, and is peeled off by a peeling roller 24. Thus the flat sheet 12 is fused and joined to the concavo-convex sheet 11 to form the air bubble sheet 10 in which a gas is sealed in the air bubble portion 13.

In the air bubble sheet 10 that is manufactured by the process described above, the height B of the side wall portion 11b is ensured in relation to the length A of the part of the air bubble portion 13 with the largest diameter, so when a load bears on the air bubble portion 13, it is possible to inhibit the flat top portion 11d from touching the bottom of the air bubble portion 13. Thus the function of the air bubble sheet 10 as a cushioning material can be ensured. Furthermore, the setting of the dimension ratios as described above for the concavo-convex sheet 11 that forms the air bubble portion 13 and the forming of the air bubble portion 13 such that its diameter becomes smaller toward the top make it possible to reduce the amount of elongation of the concavo-convex sheet 11 by the vacuum suction of the forming roller 22, making it possible to limit unevenness in the thickness of the concavo-convex sheet 11 that forms the air bubble portion 13.

In the air bubble sheet 10 according to the present embodiment, the thicknesses of the individual portions of the concavo-convex sheet 11 are such that t1 is the thickest, t2 is three-fourths of t1, t3 is one-half of t1; and t4 is three-fifths of t1. In other words, the thickness t3 of the top corner portion 11c that is the thinnest portion is one-half of the thickness t1 of the joined portion 11a that is the thickest portion.

In the structure of a known technology, the thickness t3 of a thinnest portion is one-fourth of the thickness t1 of the thickest portion, so in comparison to the known technology, the structure according to the present embodiment significantly reduces the difference between the thickness t3 of the thinnest portion and the thickness t1 of the thickest portion. It is therefore possible to make nearly uniform the thicknesses of the various portions of the concavo-convex sheet 11 that forms the air bubble portion 13.

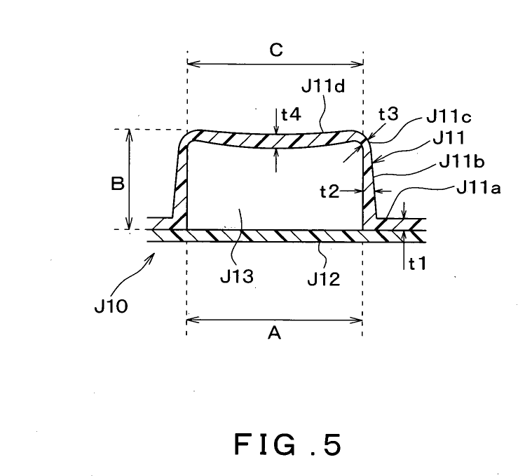

This means that even if the thickness of the concavo-convex sheet 11 that forms the air bubble portion 13 is made thin, a strength that is equivalent to that of the known air bubble sheet can be ensured. According to studies by the inventor, when compared to the known air bubble sheet J10 shown in FIG. 5, the air bubble sheet 10 according to the present embodiment, shown in FIG. 3, can ensure the same level of strength while reducing the amount of raw material used by approximately 20%.

Thus the air bubble sheet 10 according to the present embodiment can be made approximately 20% lighter than the known technology. Further, the air bubble sheet 10 is ordinarily stored and transported in a state of being rolled up into a roll shape, and because the air bubble sheet according to the present embodiment can occupy 20% less volume than the known technology, it can greatly improve storage efficiency during storage and loading efficiency during transport.

Because the air bubble sheet 10 according to the present embodiment can reduce the amount of the raw material that is used, it also contributes to conservation of petroleum resources. Moreover, when the air bubble sheet 10 according to the present embodiment is discarded and burned, it can reduce fuel calorie consumption by approximately 20% and reduce the amount of carbon dioxide emissions by approximately 20%.

### Other Embodiment

Note that in the embodiment described above, the described two-layer air bubble sheet 10 is formed from the one concavo-convex sheet 11 and the one flat sheet 12, but the present invention can also be applied to a three-layer air bubble sheet that is formed from one concavo-convex sheet that is sandwiched between two flat sheets.

1. A synthetic resin air bubble sheet in which a concavo-convex sheet and a flat sheet are joined and a plurality of air bubble portions are formed that form sealed spaces between the concavo-convex sheet and the flat sheet, characterized in that:
each of the air bubble portions has a circular truncated cone shape whose diameter becomes smaller toward the top, and where A is the diameter of the part with the largest diameter, a height B from the flat sheet is in the range of 35% to 40% of A, a diameter C of a flat top portion, which is the part with the smallest diameter, is in the range of 50% to 80% of A, and a radius of curvature R of a top corner portion that is formed between the flat top portion and a side wall portion is in the range of 10% to 20% of A.
